(19) United States
(12) Patent Application Publication
(10) Pub. No.: US 2026/0289102 A1
(43) Pub. Date: Sep. 24, 2026

(54) VIDEO PROCESSING METHOD, APPARATUS, DEVICE, MEDIUM, AND PROGRAM PRODUCT

(71) Applicant: Beijing Zitiao Network Technology Co., Ltd., Beijing (CN)

(72) Inventors: Weibo GONG, Beijing (CN); Lu LEI, Beijing (CN); Zishan SONG, Beijing (CN); Xin LI, Beijing (CN)

(21) Appl. No.: 19/575,525

(22) Filed: Mar. 23, 2026

(30) Foreign Application Priority Data
Mar. 21, 2025 (CN) 202510346292.2

(51) Int. Cl. G06F 40/186; G06F 3/0484; G06F 40/106; G06F 40/169; G11B 27/036; H04N 21/488

(52) U.S. Cl. CPC G06F 40/186; G06F 3/0484; G06F 40/106; G06F 40/169; G11B 27/036; H04N 21/4884

(57) ABSTRACT

Embodiments of the present disclosure provide a video processing method and apparatus, a device, a medium, and a program product. The method includes: displaying a video and a first control in a first interface; in response to a trigger operation for the first control, determining at least one candidate subtitle template according to a subtitle text of the video and annotation information of the subtitle text, and displaying a subtitle style interface in which the at least one candidate subtitle template is displayed; and in response to a trigger operation for the at least one candidate subtitle template, determining a target subtitle template from the at least one candidate subtitle template, generating a target video according to at least one effect material in the target subtitle template and the video, and displaying the target video in the first interface.

### CROSS-REFERENCE TO RELATED APPLICATION(S)

This application claims priority to Chinese Application No. 202510346292.2 filed on Mar. 21, 2025, the disclosure of which is incorporated herein by reference in its entity.

### FIELD

Embodiments of the present disclosure relate to computer technologies, and in particular, to a video processing method and apparatus, a device, a medium, and a program product.

### BACKGROUND

With the development of computer technologies, videos have become an important information transmission medium due to the intuitiveness and richness of their information content. Video subtitles may help audiences better watch videos.

### SUMMARY

Embodiments of the present disclosure provide a video processing method and apparatus, a device, a medium, and a program product.

In a first aspect, an embodiment of the present disclosure provides a video processing method, including:

displaying, in a first interface, a video and a first control;

determining, in response to a trigger operation for the first control, at least one candidate subtitle template according to a subtitle text of the video and annotation information of the subtitle text, and displaying a subtitle style interface in which the at least one candidate subtitle template is displayed, where the candidate subtitle template includes at least one effect material; and

determining, in response to a trigger operation for the at least one candidate subtitle template, a target subtitle template from the at least one candidate subtitle template, and generating a target video according to the at least one effect material in the target subtitle template and the video, and displaying the target video in the first interface.

In a second aspect, an embodiment of the present disclosure further provides a video processing apparatus, including:

a first display module, configured to display, in a first interface, a video and a first control;

a second display module, configured to, determine, in response to a trigger operation for the first control, at least one candidate subtitle template according to a subtitle text of the video and annotation information of the subtitle text, and display a subtitle style interface in which the at least one candidate subtitle template is displayed, where the candidate subtitle template includes at least one effect material; and

a video generation module, configured to, determine, in response to a trigger operation for the at least one candidate subtitle template, determine a target subtitle template from the at least one candidate subtitle template, and generate a target video according to the at least one effect material in the target subtitle template and the video, and display the target video in the first interface.

In a third aspect, an embodiment of the present disclosure further provides an electronic device, where the electronic device includes:

one or more processors,

a storage apparatus, configured to store one or more programs,

when the one or more programs are executed by the one or more processors, the one or more processors are caused to implement the video processing method according to any embodiment of the present disclosure.

In a fourth aspect, an embodiment of the present disclosure further provides a storage medium including computer-executable instructions, where when the computer-executable instructions are executed by a computer processor, the video processing method according to any embodiment of the present disclosure is performed.

In a fifth aspect, an embodiment of the present disclosure further provides a computer program product, including a computer program, where when the computer program is executed by a processor, the video processing method according to any embodiment of the present disclosure is implemented.

### BRIEF DESCRIPTION OF THE DRAWINGS

The foregoing and other features, advantages, and aspects of the embodiments of the present disclosure become more apparent with reference to the following specific implementations and in conjunction with the drawings. Throughout the drawings, the same or similar reference numerals denote the same or similar elements. It should be understood that the drawings are schematic and that parts and elements are not necessarily drawn to scale.

FIG. 1 is a schematic flowchart of a video processing method according to an embodiment of the present disclosure;

FIG. 2 is a schematic diagram of an interaction according to an embodiment of the present disclosure;

FIG. 3 is a schematic diagram of a first interface according to an embodiment of the present disclosure;

FIG. 4 is a schematic diagram of another interaction according to an embodiment of the present disclosure;

FIG. 5 is a schematic diagram of still another interaction according to an embodiment of the present disclosure;

FIG. 6 is a schematic diagram of still another interaction according to an embodiment of the present disclosure;

FIG. 7 is a schematic flowchart of another video processing method according to an embodiment of the present disclosure;

FIG. 8 is a schematic flowchart of still another video processing method according to an embodiment of the present disclosure;

FIG. 9 is an architecture diagram of a subtitle style prediction model according to an embodiment of the present disclosure;

FIG. 10 is a schematic diagram of a structure of a video processing apparatus according to an embodiment of the present disclosure; and

FIG. 11 is a schematic diagram of a structure of an electronic device according to an embodiment of the present disclosure.

### DETAILED DESCRIPTION OF EMBODIMENTS

Embodiments of the present disclosure are described in more detail below with reference to the drawings. Although some embodiments of the present disclosure are shown in the drawings, it should be understood that the present disclosure may be implemented in various forms and should not be construed as limited to the embodiments set forth herein. Instead, these embodiments are provided for a more thorough and complete understanding of the present disclosure. It should be understood that the drawings and embodiments of the present disclosure are only for exemplary purposes and are not intended to limit the protection scope of the present disclosure.

It should be understood that steps described in method implementations of the present disclosure may be performed in different orders and/or in parallel. In addition, the method implementations may include additional steps and/or omit the steps shown. The scope of the present disclosure is not limited in this regard.

The term “include/comprise” and its variants used herein are open-ended inclusions, that is, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of other terms are given in the description below.

It should be noted that concepts such as “first” and “second” mentioned in the present disclosure are only used to distinguish different apparatuses, modules, or units, and are not used to limit the sequence or interdependence of the functions performed by these apparatuses, modules, or units.

It should be noted that modifications of “one” and “a plurality of” mentioned in the present disclosure are schematic rather than restrictive, and those skilled in the art should understand that unless otherwise explicitly specified in the context, they should be understood as “one or more”.

The names of messages or information exchanged between a plurality of apparatuses in the implementations of the present disclosure are only for illustrative purposes, and are not intended to limit the scope of these messages or information.

It may be understood that before the use of the technical solutions disclosed in the embodiments of the present disclosure, the user should be informed of the type, range of use, use scenarios, etc. of personal information involved in the present disclosure in an appropriate manner and the authorization of the user should be obtained according to relevant laws and regulations.

For example, in response to reception of an active request from a user, prompt information is sent to the user to clearly prompt the user that the requested operation will require access to and use of personal information of the user. Thus, the user may independently choose, based on the prompt information, whether to provide the personal information to software or hardware, such as an electronic device, an application, a server, or a storage medium, that performs the operations of the technical solutions of the present disclosure.

As an optional but non-restrictive implementation, in response to the reception of the active request from the user, the prompt information may be sent to the user in the form of, for example, a pop-up window, in which the prompt information may be presented in text. In addition, the pop-up window may also include a selection control for the user to choose whether to “agree” or “disagree” to provide the personal information to the electronic device.

It may be understood that the above process of notifying and obtaining user authorization is only schematic and does not limit the implementations of the present disclosure, and other manners that satisfy the relevant laws and regulations may also be applied to the implementations of the present disclosure.

It may be understood that data involved in the technical solution (including but not limited to the data itself, acquisition or use of the data) should comply with the requirements of corresponding laws, regulations, and related provisions.

In the related art, video subtitles usually need to be manually added. At present, video subtitles include only text information, and the form of subtitles is relatively single, which affects the display effect of video content, resulting in poor user experience.

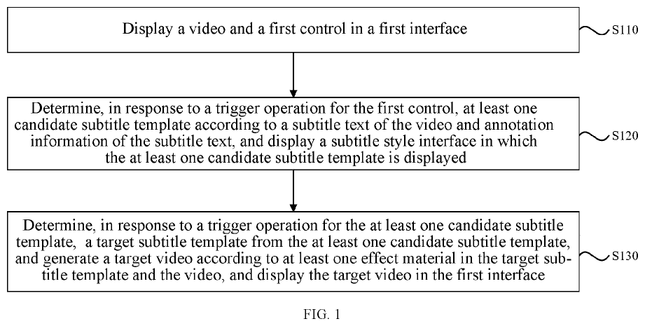

FIG. 1 is a schematic flowchart of a video processing method according to an embodiment of the present disclosure. The embodiment of the present disclosure is applicable to a case where a subtitle is added to a video. The method may be performed by a video processing apparatus, which may be implemented in the form of software and/or hardware. Optionally, the method is implemented by an electronic device, which may be a mobile terminal, a PC, a server, or the like.

As shown in FIG. 1, the method includes the following steps.

S110, a video and a first control are displayed in a first interface.

Among them, the video represents a video to which a subtitle effect is to be added. The video may include a subtitle, or the video may not include a subtitle, and a subtitle is determined in subsequent processing by recognition of audio information of a target object in the video. For example, the video may include a voice-over video, a video clip of a film and television work, a commentary video of a film and television work, etc.

The first interface includes a preview interface or an editing interface. The preview interface includes at least one preview area. The editing interface includes a preview area and an editing track area, and an editing track is displayed in the editing track area.

The first control is configured to trigger a subtitle style adjustment event. For example, the first control may be a control in a function area at the bottom of the first interface. The first interface is divided into a video preview area, a subtitle preview area, and a function area according to a preset layout style. The video is displayed in the video preview area. A normal subtitle of the video is displayed in the subtitle preview area. The normal subtitle represents a subtitle text to which an effect is not added.

Exemplarily, the first control, the video, and a subtitle of the video are displayed in the first interface, where the subtitle of the video is associated with the subtitle text. The subtitle style interface may be invoked through the trigger operation for the first control, to intuitively display the at least one candidate subtitle template. In addition, the video subtitle displayed in the video preview area is the same as the subtitle text in a selected state in the subtitle preview area, and the video voice content corresponding to the subtitle text in the selected state is synchronously played, so that the video content may be displayed from both visual and auditory aspects.

Optionally, if the subtitle text is non-Mandarin content, a fourth control is displayed in the first interface, where the fourth control is configured to trigger a conversion event of converting the non-Mandarin content into Mandarin content.

Optionally, a batch editing control may also be displayed at the bottom of the first interface. In response to a trigger operation for the batch editing control, a subtitle editing interface is displayed. The subtitle editing interface may be in a full-screen form. The subtitle text of the video is displayed in the subtitle editing interface, thereby implementing an edit operation for the video subtitle corresponding to any video frame.

Optionally, in response to a trigger operation for a single sentence subtitle in the subtitle preview area in the first interface, an input box and a virtual keyboard are displayed, and the single sentence subtitle is displayed in the input box.

Optionally, an all-delete control may also be displayed at the bottom of the first interface. In response to a trigger operation for the all-delete control, a preset prompt pop-up window is displayed to prompt the user to confirm whether to perform an operation of deleting the video subtitle for the video.

Optionally, displaying the first control, the video, and the subtitle of the video in the first interface includes: displaying the video and a second control in a second interface, where the second control is configured to trigger an event of adding a subtitle to the video; in response to a trigger operation for the second control, determining the subtitle text according to an audio feature of the video, and annotating the subtitle text to obtain the annotation information; and displaying the first interface, and displaying the first control, the video, and the subtitle of the video in the first interface.

Among them, the second interface may be an editing interface. The video and the second control are displayed in the second interface. In response to the trigger operation for the second control, the first interface is displayed, where the first interface includes the video preview area, the subtitle preview area, and the function area. In response to the trigger operation for the second control, the interface is further input to a pre-trained video understanding model to obtain the subtitle text of the video and the annotation information of the subtitle text. The first interface is displayed, where the first control is displayed in the function area of the first interface, the video is displayed in the video preview area of the first interface, and the subtitle of the video is displayed in the subtitle preview area of the first interface.

Among them, the video understanding model may be a multimodal model for outputting a subtitle text and annotation information for a video. The annotation information refers to an annotation result of specific content in the subtitle text. The specific content may be content preset according to a business scenario. Fine-grained annotation of the subtitle text is implemented through text annotation. For example, the subtitle text may be annotated based on at least one of text content, a prosodic feature in the audio information of the target object, or a linguistic feature. The prosodic feature includes a fundamental frequency, speech intensity, a speech rate, etc. The linguistic feature includes a tone, a phoneme, etc. Through the fine-grained annotation of the subtitle text, a similar effect material may be matched from the effect material library based on the annotation information, the degree of association between the effect material and the video content is increased, and a situation that the effect material is separated from the video content is avoided, thereby improving the video quality.

S120, in response to a trigger operation for the first control, at least one candidate subtitle template is determined according to a subtitle text of the video and annotation information of the subtitle text, and a subtitle style interface is displayed in which the at least one candidate subtitle template is displayed.

Among them, the candidate subtitle template includes at least one effect material. A subtitle template may be a collection of effect materials. One subtitle template corresponds to one effect material package. The effect material package includes at least one effect material file. Optionally, the at least one candidate subtitle template includes subtitle templates of different preset styles. The subtitle style interface includes at least one type of candidate subtitle template of a preset style. The style type of the subtitle template may be preset according to a business scenario. A corresponding number of placeholder identifications are set in the subtitle style interface according to the number of candidate subtitle templates of each style. Optionally, the subtitle style interface further includes a plurality of subtitle style edit items, such as edit items for color, style, or font. Exemplarily, the edit items for color, style, font, and the like further include a template effect option. After the color, style, or font of the subtitle is edited, in response to a trigger operation for the template effect option, the subtitle may present the subtitle effect of the target subtitle template.

Among them, the effect material represents a material having a specific effect. For example, the effect material includes a sticker and/or a text template, the sticker includes text or an image, and the text template includes text having a specific effect.

Exemplarily, in response to the trigger operation for the first control, the subtitle style interface is displayed, and the at least one candidate subtitle template is displayed in the subtitle style interface. It should be noted that the screen is divided into upper and lower parts according to a preset split-screen layout strategy. The video preview area in the first interface is displayed on the upper half of the screen. The subtitle style interface is displayed on the lower half of the screen. Thus, during video preview, the video subtitle effect may be edited based on the trigger operation for the at least one candidate subtitle template in the subtitle style interface.

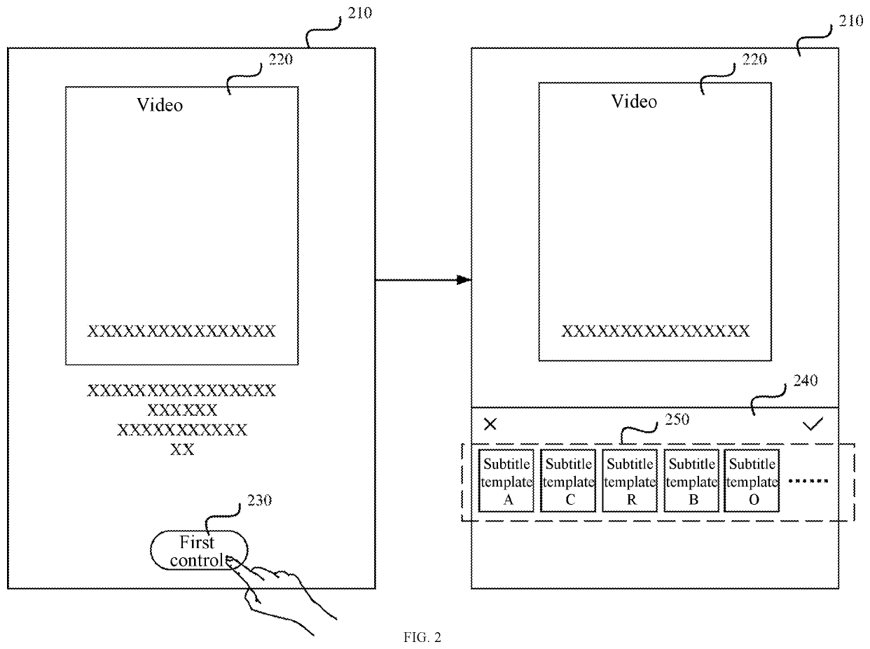

FIG. 2 is a schematic diagram of an interaction according to an embodiment of the present disclosure. As shown in FIG. 2, a video 220 and a first control 230 are displayed in a first interface 210. In response to a trigger operation for the first control 230, a subtitle style interface 240 is displayed to present an effect of simultaneously displaying a video preview area in the first interface 210 and the subtitle style interface 240. At least one candidate subtitle template 250 is displayed in the subtitle style interface 240.

S130, in response to a trigger operation for the at least one candidate subtitle template, a target subtitle template is determined from the at least one candidate subtitle template, a target video is generated according to the at least one effect material in the target subtitle template and the video, and the target video is displayed in the first interface.

Among them, the target subtitle template represents a subtitle template in a selected state in the at least one candidate subtitle template. The target video represents a video carrying the at least one effect material in the target subtitle template.

Exemplarily, an adding position of the at least one effect material in the target subtitle template in the video is determined according to a time stamp corresponding to the subtitle text. The corresponding effect material is added to the video based on the adding position, to obtain the target video, so that a video frame of the target video carries a corresponding subtitle effect.

Optionally, displaying the target video includes: displaying the target video in the video preview area of the first interface, and displaying a subtitle effect corresponding to the target subtitle template in the target video.

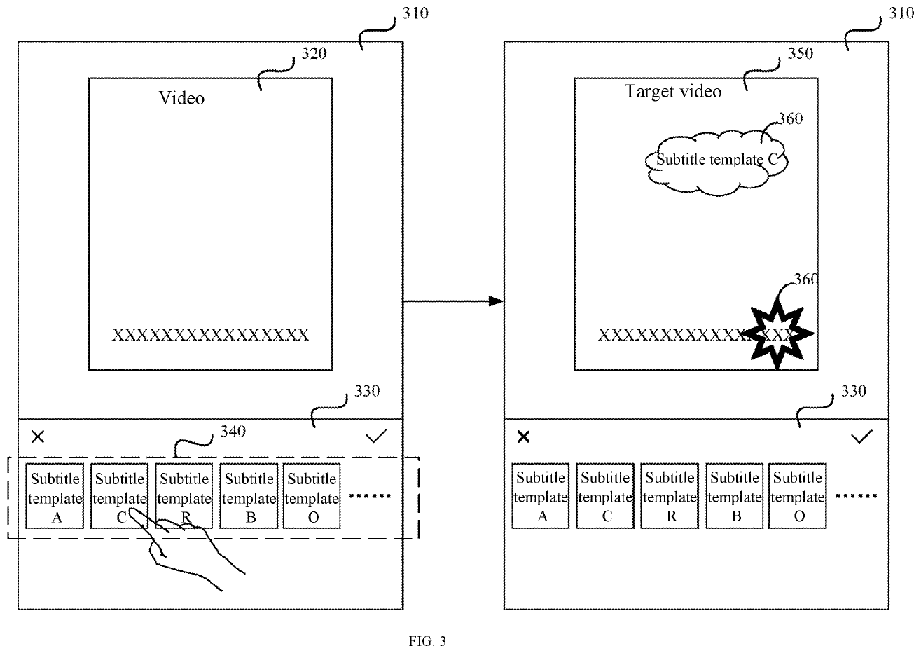

FIG. 3 is a schematic diagram of a first interface according to an embodiment of the present disclosure. As shown in FIG. 3, a video 320 is displayed in a video preview area of a first interface 310, and at least one candidate subtitle template 340 is displayed in a subtitle style interface 330. The at least one candidate subtitle template 340 includes a subtitle template A, a subtitle template C, a subtitle template R, a subtitle template B, and a subtitle template O. In response to a trigger operation for the at least one candidate subtitle template 340, the subtitle template C is determined as a target subtitle template. A target video 350 is displayed in the video preview area of the first interface 310, and a subtitle effect 360 corresponding to the subtitle template C is displayed in the target video 350. For example, the subtitle effect 360 includes clouds and stars in FIG. 3.

Optionally, the first interface includes a preview interface or an editing interface.

In some embodiments, displaying the target video in the first interface includes: displaying the target video in the preview interface; and in response to an edit operation for an effect material in the target video, performing edit processing on the effect material, where the edit operation includes at least one of a shifting operation, a deleting operation, or a flipping operation.

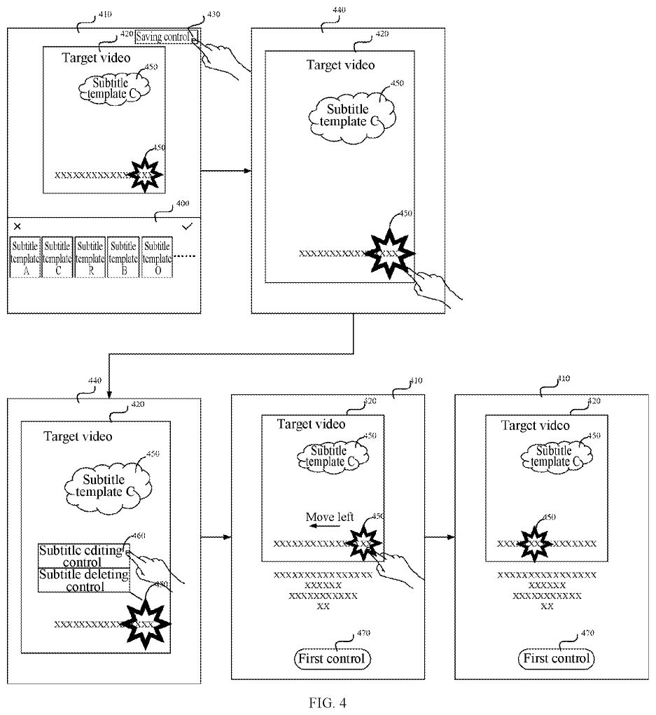

FIG. 4 is a schematic diagram of another interaction according to an embodiment of the present disclosure. As shown in FIG. 4, a subtitle style interface 400 and a first interface 410 are displayed on a screen. A target video 420 and a saving control 430 are displayed in the first interface 410. In response to a trigger operation for the saving control 430, a second interface 440 is displayed. The target video 420 is displayed in the second interface 440, and an effect material 450 is displayed in a video frame of the target video 420. In response to a trigger operation for the effect material 450, a preset control is displayed. The preset control includes a subtitle editing control 460 and a subtitle deleting control. In response to a trigger operation for the subtitle editing control 460, the first interface 410 is displayed, where the target video 420, a subtitle text, and a first control 470 are displayed in the first interface 410, and the effect material 450 is displayed in the video frame of the target video 420. In response to an edit operation for the effect material 450, at least one of shifting processing, deleting processing, or reversing processing is performed on the effect material 450 displayed in the first interface 410.

Optionally, a third control is displayed in the preview interface, where the third control is configured to trigger an edit event for the target video. In response to a trigger operation for the third control, the editing interface is displayed, and the editing track is displayed in the editing interface, where the editing track includes a text track and/or a sticker track. In response to an edit operation for the text track and/or the sticker track, edit processing is performed on the subtitle text in the text track, and/or edit processing is performed on the sticker effect in the sticker track. The third control may be an editing control or the like.

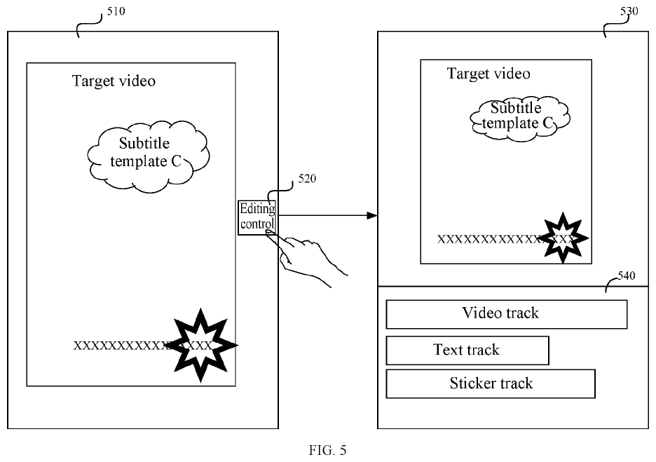

FIG. 5 is a schematic diagram of another interaction according to an embodiment of the present disclosure. As shown in FIG. 5, an editing control 520 is displayed in a preview interface 510. In response to a trigger operation for the editing control 520, an editing interface 530 is displayed. An editing track is displayed in an editing track area 540 in the editing interface 530. The editing track includes a text track and/or a sticker track.

In some other embodiments, displaying the target video in the first interface includes:

displaying the target video and an editing track in the editing interface, where the editing track includes an effect track, the effect track includes a text track and/or a sticker track, the text track includes the subtitle text, and the sticker track includes a sticker effect.

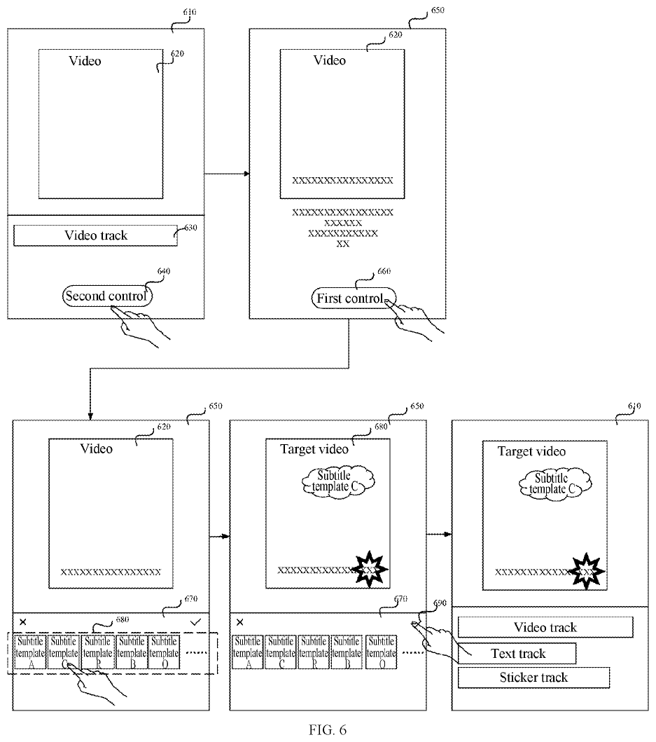

FIG. 6 is a schematic diagram of another interaction according to an embodiment of the present disclosure. As shown in FIG. 6, a video 620, an editing track 630, and a second control 640 are displayed in an editing interface 610. The editing track 630 includes a video track. In response to a trigger operation for the second control 640, a preview interface 650 is displayed. The video 620, a subtitle text, and a first control 660 are displayed in the preview interface 650. In response to a trigger operation for the first control 660, a subtitle style interface 670 is displayed. The subtitle style interface 670 includes at least one candidate subtitle template 680. In response to a trigger operation for the at least one candidate subtitle template 680, a target video 680 and a confirmation control 690 are displayed in the preview interface 650. In response to a trigger operation for the confirmation control 690, the editing interface 610 is displayed. The target video, the video track, the text track, and the sticker track are displayed in the editing interface 610.

In the technical solutions of the embodiments of the present disclosure, the video and the first control are displayed in the first interface; in response to the trigger operation for the first control, the at least one candidate subtitle template is determined according to the subtitle text of the video and the annotation information of the subtitle text, and the at least one candidate subtitle template is displayed in the subtitle style interface; and in response to the trigger operation for the at least one candidate subtitle template, the target subtitle template is determined from the at least one candidate subtitle template, the target video is generated according to the at least one effect material in the target subtitle template and the video, and the target video is displayed. In the embodiments of the present disclosure, the candidate subtitle template associated with the video subtitle is determined based on the subtitle text of the video and the annotation information of the subtitle text, so that a candidate subtitle template with higher degree of fit with the video subtitle may be obtained. By applying the candidate subtitle template, the at least one effect material may be added to the video, the editing efficiency of subtitle effects may be improved, and the subtitle effects of the video may be enriched, thereby solving the problem of a single form of subtitles in the related art. With the rich subtitle effects, the video content may be made more vivid, thereby enriching the video display effect and improving the user experience.

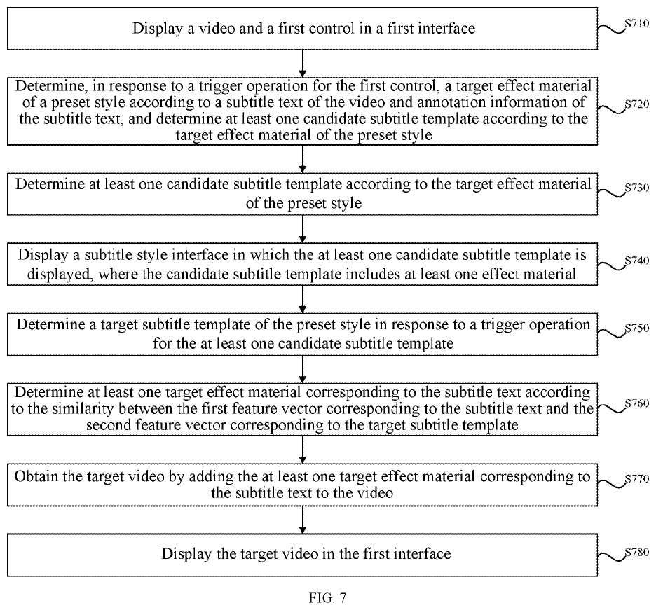

FIG. 7 is a schematic flowchart of another video processing method according to an embodiment of the present disclosure. In the embodiment of the present disclosure, a manner of determining the candidate subtitle template and a manner of applying the target subtitle template are further defined based on the preceding embodiments.

As shown in FIG. 7, the method includes the following steps.

S710, a video and a first control are displayed in a first interface.

S720, in response to a trigger operation for the first control, target subtitle content in a subtitle text is determined according to annotation information of the subtitle text, and a target effect material of a preset style is determined according to a similarity between the target subtitle content and an effect material of the preset style in an effect material library.

Among them, the target subtitle content represents the text content corresponding to the annotation information in the subtitle text. For example, the annotation information includes at least one of style, price, place, item, style representation, etc. For each piece of subtitle text, the text content corresponding to the annotation information in the subtitle text is extracted as the target subtitle content of the current piece of subtitle text. The preset style represents the effect material style of the subtitle candidate template. The preset style includes different style types such as a variety show sense, a parent-child style, daily life, and professionalism.

For each piece of subtitle text, the similarity between the target subtitle content of the current piece of subtitle text and the effect material of the preset style in the effect material library is calculated. At least one effect material similar to the target subtitle content is obtained from the effect materials of the preset style according to the similarity, and used as the target effect material of the current piece of subtitle text. The at least one candidate subtitle template of the preset style is determined according to the target effect material of each subtitle in the subtitle text. Optionally, the candidate subtitle template of each preset style includes at least one target effect material of each piece of subtitle text of the video. For example, the candidate subtitle template with a variety show sense includes at least one target effect material of a variety show style of each piece of subtitle text of the video.

Exemplarily, determining the target effect material of the preset style according to the similarity between the target subtitle content and the effect material of the preset style in the effect material library includes: determining a first feature vector according to the target subtitle content; determining a second feature vector according to an effect name and an effect preview image of the effect material of the preset style; and determining the target effect material according to the similarity between the first feature vector and the second feature vector.

According to the embodiments of the present disclosure, similarity matching with the target subtitle content may be performed from two aspects of the name and the preview image of the effect material, to obtain a text template and a sticker effect with high similarity to the target subtitle content, thereby improving the richness of the effect materials, and avoiding missing effect materials with high similarity to the target subtitle content, and improving the recall rate of the effect materials.

For example, vectorization processing is performed on the target subtitle content to obtain the first feature vector. Vectorization processing is performed on the effect name of the effect material of the preset style to obtain a name vector. The description text corresponding to the effect preview image of the effect material of the preset style is determined, and vectorization processing is performed on the description text to obtain a preview image vector. The name vector and the preview image vector are concatenated to obtain the second feature vector. The target effect material in the effect material of the preset style is determined according to the cosine similarity between the first feature vector and the second feature vector.

In some embodiments, the effect material of the preset style whose cosine similarity associated with each piece of subtitle text exceeds a preset similarity threshold is determined, the determined effect materials are sorted according to the cosine similarity, and the target effect material in the effect material of the preset style is determined according to the sorting result. For example, in the case of descending order, n effect materials are selected from the head of the sorting result of the effect material of the preset style and used as the target effect material. In the case of ascending order, n effect materials are selected from the tail of the sorting result of the effect material of the preset style and used as the target effect material. Here, n is a positive integer associated with the number of placeholder identifications of the candidate subtitle template of the same style. Alternatively, n is a preset positive integer.

S730, at least one candidate subtitle template is determined according to the target effect material of the preset style.

Exemplarily, the n target effect materials of the preset style are divided into a plurality of groups according to the number of placeholder identifications of the candidate subtitle template of the preset style, to obtain the at least one candidate subtitle template of the preset style. For example, according to the number of placeholder identifications of a candidate subtitle template with a variety show style, at least one target effect material of a variety show style corresponding to each piece of subtitle text is allocated to each candidate subtitle template with the variety show style, to obtain a number of candidate subtitle templates corresponding to the number of placeholder identifications. Each candidate subtitle template includes target effect materials of the variety show style corresponding to all pieces of subtitle text of the video.

S740, a subtitle style interface is displayed in which the at least one candidate subtitle template is displayed, where the candidate subtitle template includes at least one effect material.

S750, in response to a trigger operation for the at least one candidate subtitle template, a target subtitle template of the preset style is determined.

Exemplarily, in response to a selection operation for the at least one candidate subtitle template, the selected candidate subtitle template is determined as the target subtitle template. The target subtitle template is converted into the selected state, and preset prompt text is displayed at the display position of the video in the first interface to prompt that the target subtitle template is currently applied to the video.

S760, at least one target effect material corresponding to the subtitle text is determined according to the similarity between the first feature vector corresponding to the subtitle text and the second feature vector corresponding to the target subtitle template.

Exemplarily, for each piece of subtitle text, at least one target effect material corresponding to the current piece of subtitle text is determined according to the cosine similarity between the first feature vector corresponding to the current piece of subtitle text and the second feature vector of the target effect material in the target subtitle template.

For example, for target effect materials such as a sticker and a text template in the target subtitle template, a type of target effect material with the highest cosine similarity is used as the at least one target effect material corresponding to the current piece of subtitle text. If there are second feature vectors of a sticker and a text template whose cosine similarity with the first feature vector of the current piece of subtitle text exceeds a preset similarity threshold, the at least one target effect material of the current piece of subtitle text is determined according to the sticker and the text template with the highest cosine similarity, respectively.

S770, the at least one target effect material corresponding to the subtitle text is added to the video to obtain the target video.

S780, the target video is displayed in the first interface.

In the technical solutions of the embodiments of the present disclosure, the target subtitle content in the subtitle text is determined based on the annotation information of each piece of subtitle text having the annotation information, the target effect material of the preset style is determined according to the similarity between the target subtitle content and the effect material of the preset style in the effect material library, and the at least one candidate subtitle template is determined according to the target effect material of the preset style, and the at least one candidate subtitle template is displayed in the subtitle style interface, to implement matching the corresponding candidate subtitle template in the effect material library based on the video content. The at least one target effect material corresponding to the subtitle text is determined by the similarity between the first feature vector corresponding to the subtitle text and the second feature vector corresponding to the target subtitle template, so that the degree of fit between the effect material and the video content may be improved, and a situation that the effect material is separated from the video content may be avoided. Based on the correspondence between the subtitle text and the effect material, the effect material is added to the video to obtain the target video, to implement applying the effect material of the target subtitle template to the entire video, thereby improving the subtitle editing efficiency.

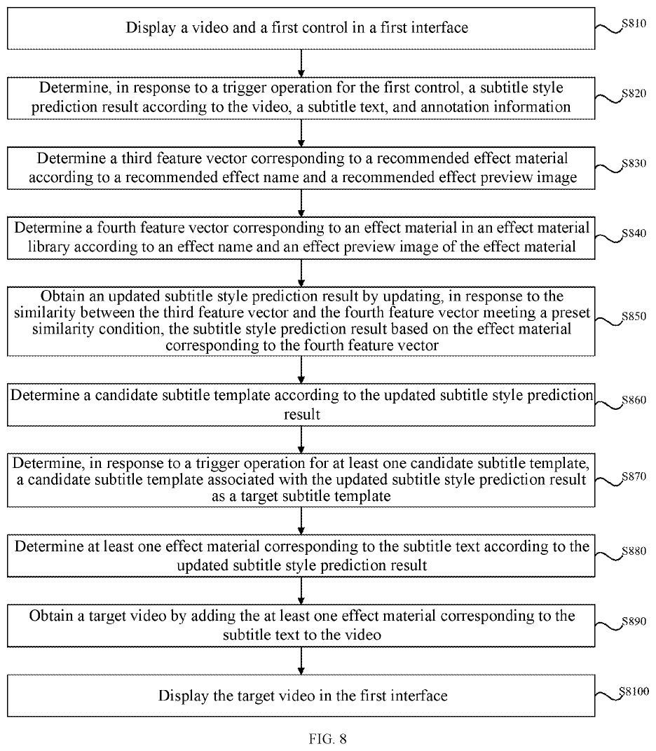

FIG. 8 is a schematic flowchart of another video processing method according to an embodiment of the present disclosure. In the embodiment of the present disclosure, a manner of determining the candidate subtitle template and a manner of applying the target subtitle template are further defined based on the preceding embodiments.

As shown in FIG. 8, the method includes the following steps.

S810, a video and a first control is displayed in a first interface.

S820, in response to a trigger operation for the first control, a subtitle style prediction result is determined according to the video, a subtitle text, and annotation information.

Among them, the subtitle style prediction result includes the subtitle text and a recommended effect material, and the recommended effect material includes a recommended effect name and a recommended effect preview image. In some embodiments, the subtitle style prediction result includes the subtitle text, the recommended effect material, and a correspondence between the subtitle text and the recommended effect material.

Exemplarily, in response to the trigger operation for the first control, the video, the subtitle text of the video, and the annotation information of the subtitle text are input to a pre-trained subtitle style prediction model, and the subtitle style prediction result output by the subtitle style prediction model is obtained. Among them, the subtitle style prediction model may include a text preprocessing module, a visual encoding module, a visual-language adaptation module, and a large language model. The large language model may be a deep learning model that performs unsupervised training on a large amount of text data to learn natural language patterns, grammatical structures, and semantic relationships. The large language model captures long-distance dependencies in the text through a self-attention mechanism. The text preprocessing module is configured to convert text into a sequence and perform vectorization processing. The visual encoding module is configured to convert a video frame into a visual feature vector. The visual-language adaptation module is configured to map the visual feature vector to a text feature space.

A training sample set may be determined through a video sample whose subtitle effect meets expectations. Fine-tuning training is performed for the large language model through the training sample set, so that the large language model may learn design elements and rules of the effect material in the video sample, and generate the subtitle style prediction result that meets expectations based on the design elements and rules. For example, a timestamp of the video sample, the subtitle text, and a preset prompt are input to the text preprocessing module, and the timestamp of the video sample, the subtitle text, and the preset prompt are vectorized by the text preprocessing module to obtain a text feature vector. Among them, the preset prompt may include subtitle style description information and the like. A video sequence of the video sample is input to the visual encoding module, and a video frame is converted into the visual feature vector by the visual encoding module, and the visual feature vector is output to the visual-language adaptation module. The visual feature vector is mapped to the text feature space by the visual-language adaptation module to obtain the visual feature mapping result. The text feature vector is input to the large language model by the text preprocessing module, the visual feature mapping result is input to the large language model by the visual-language adaptation module, and the subtitle style prediction result output by the large language model is obtained. Prediction loss is calculated according to the subtitle style prediction result and subtitle effect information of the video sample. Model parameters of the large language model and the visual-language adaptation module are adjusted according to the prediction loss to complete the fine-tuning training of the subtitle style prediction model.

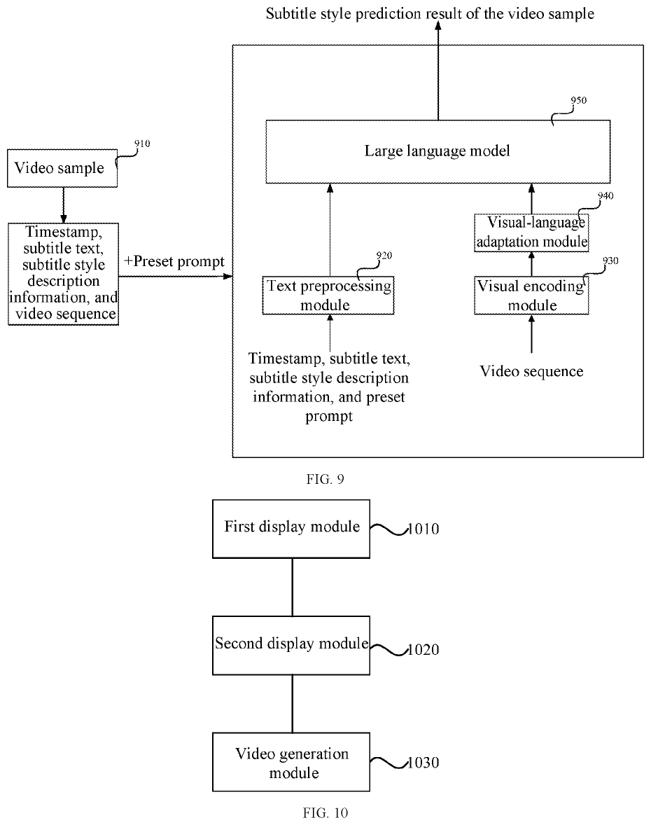

FIG. 9 is an architecture diagram of a subtitle style prediction model according to an embodiment of the present disclosure. As shown in FIG. 9, a timestamp, a subtitle text, subtitle style description information, and a video sequence are determined according to a video sample 910. Among them, the subtitle style description information is associated with a subtitle effect in the video sample 910. The subtitle style description information, a preset prompt, the timestamp, and the subtitle text are input to a text preprocessing module 920. The video sequence is input to a visual encoding module 930. The text feature vector is output by the text preprocessing module 920. The visual feature vector is input to a visual-language adaptation module 940 by the visual encoding module 930. The visual feature vector is mapped to the text feature space by the visual-language adaptation module 940 to obtain the visual feature mapping result. The text feature vector and the visual feature mapping result are input to a large language model 950, and the design elements and rules of the effect material in the video sample are learned by the large language model to generate the subtitle style prediction result of the video sample.

S830, a third feature vector corresponding to the recommended effect material is determined according to the recommended effect name and the recommended effect preview image.

S840, a fourth feature vector corresponding to an effect material in an effect material library is determined according to an effect name and an effect preview image of the effect material.

Exemplarily, the recommended effect name, the recommended effect preview image, a recommended name of the effect material in the effect material library, and a recommended preview image are input to a pre-trained effect mapping model, and the recommended effect name of the recommended effect, the recommended effect preview image, the effect name of the effect material in the effect material library, and the effect preview image are mapped to the same vector by the effect mapping model. A feature vector of the recommended feature name and a feature vector of the recommended effect preview image in the same vector are concatenated to obtain the third feature vector corresponding to the recommended effect material. A feature vector of the effect name of the effect material and a feature vector of the effect preview image in the same vector are concatenated to obtain the fourth feature vector corresponding to the effect material.

In some embodiments, the effect mapping model is a multimodal model trained based on an effect material pair with similar effect materials. For example, an effect material pair with similar effect materials is input to the effect mapping model to be trained, and a similarity prediction result of the effect material pair is output by the effect mapping model. Then, contrastive loss is determined according to a true value of the similarity of the effect material pair and the prediction result, and the effect mapping model is trained according to the contrastive loss.

The recommended effect material is mapped to the effect material in the effect material library that is not trained by the subtitle style prediction model through the effect mapping model, so that the subtitle style prediction capability of the subtitle style prediction model may be transferred to the effect material library not participating in the model training, thereby improving the generalization capability of the subtitle style prediction result.

S850, in response to the similarity between the third feature vector and the fourth feature vector meeting a preset similarity condition, an updated subtitle style prediction result is obtained by updating the subtitle style prediction result based on the effect material corresponding to the fourth feature vector.

Exemplarily, the updating the subtitle style prediction result based on the effect material corresponding to the fourth feature vector includes: replacing the effect material corresponding to the third feature vector in the subtitle style prediction result with the effect material corresponding to the fourth feature vector.

For example, the fourth feature vector associated with the maximum similarity in the preset effect material library is determined according to the similarity between the third feature vector and the fourth feature vector. The recommended effect material corresponding to the third feature vector is replaced with the effect material corresponding to the fourth feature vector associated with the maximum similarity.

S860, the candidate subtitle template is determined according to the updated subtitle style prediction result.

Exemplarily, the candidate subtitle template is determined according to the effect material in the updated subtitle style prediction result.

S870, in response to a trigger operation for the at least one candidate subtitle template, a candidate subtitle template associated with the updated subtitle style prediction result is determined as the target subtitle template.

S880, at least one effect material corresponding to the subtitle text is determined according to the updated subtitle style prediction result.

Since the subtitle style prediction result includes the correspondence between the subtitle text and the recommended effect material, and the subtitle style prediction result is updated by updating the effect material, the updated subtitle style prediction result also includes the correspondence between the subtitle text and the effect material. The at least one effect material corresponding to the subtitle text is determined based on the correspondence between the subtitle text and the effect material in the updated subtitle style prediction result.

S890, the target video is obtained by adding the at least one effect material corresponding to the subtitle text to the video.

S8100, the target video is displayed in the first interface.

In the technical solutions of the embodiments of the present disclosure, the subtitle style prediction result is determined based on the video, the subtitle text, and the annotation information, and the recommended effect material in the subtitle style prediction result is mapped to the similar effect material in the material library to obtain the updated subtitle style prediction result, thereby improving the generalization capability of the subtitle style prediction result. The at least one candidate subtitle template is determined according to the updated subtitle style prediction result. In response to the trigger operation for the at least one candidate subtitle template, the candidate subtitle template associated with the updated subtitle style prediction result is determined as the target subtitle template, and based on the correspondence between the subtitle text and the effect material in the updated subtitle style prediction result, the effect material is added to the video to obtain the target video, to implement applying the effect material of the target subtitle template to the entire video, thereby improving the subtitle editing efficiency.

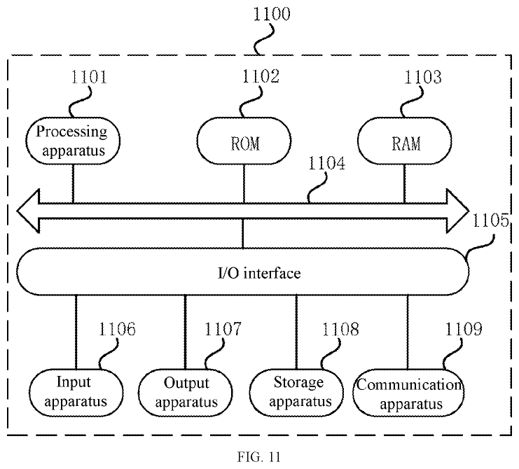

FIG. 10 is a schematic diagram of a structure of a video processing apparatus according to an embodiment of the present disclosure. The apparatus may be implemented in the form of software and/or hardware, and optionally, by an electronic device. The electronic device may be a mobile terminal, a PC, a server, or the like.

As shown in FIG. 10, the apparatus includes: a first display module 1010, a second display module 1020, and a video generation module 1030.

The first display module 1010 is configured to display, in a first interface, a video and a first control;

the second display module 1020 is configured to, determine, in response to a trigger operation for the first control, at least one candidate subtitle template according to a subtitle text of the video and annotation information of the subtitle text, and display a subtitle style interface in which the at least one candidate subtitle template is displayed, where the candidate subtitle template includes at least one effect material;

the video generation module 1030 is configured to, determine, in response to a trigger operation for the at least one candidate subtitle template, a target subtitle template from the at least one candidate subtitle template, and generate a target video according to the at least one effect material in the target subtitle template and the video, and display the target video in the first interface.

Optionally, determining at least one candidate subtitle template according to the subtitle text of the video and the annotation information of the subtitle text includes:

determining target subtitle content in the subtitle text according to the annotation information of the subtitle text, and determining a target effect material of a preset style according to a similarity between the target subtitle content and an effect material of the preset style in an effect material library; and

determining at least one candidate subtitle template according to the target effect material of the preset style.

Optionally, determining the target effect material of the preset style according to the similarity between the target subtitle content and the effect material of the preset style in the effect material library includes:

determining a first feature vector according to the target subtitle content;

determining a second feature vector according to an effect name and an effect preview image of the effect material of the preset style; and

determining the target effect material according to the similarity between the first feature vector and the second feature vector.

Optionally, the determining a target subtitle template from the at least one candidate subtitle template, and generating a target video according to the at least one effect material in the target subtitle template and the video in response to a trigger operation for the at least one candidate subtitle template includes:

determining the target subtitle template of the preset style in response to the trigger operation for the at least one candidate subtitle template;

determining at least one target effect material corresponding to the subtitle text according to the similarity between the first feature vector corresponding to the subtitle text and the second feature vector corresponding to the target subtitle template; and

adding the at least one target effect material corresponding to the subtitle text to the video to obtain the target video.

Optionally, the determining at least one candidate subtitle template according to the subtitle text of the video and the annotation information of the subtitle text includes:

determining a subtitle style prediction result according to the video, the subtitle text, and the annotation information, where the subtitle style prediction result includes the subtitle text and a recommended effect material, and the recommended effect material includes a recommended effect name and a recommended effect preview image;

determining a third feature vector corresponding to the recommended effect material according to the recommended effect name and the recommended effect preview image;

determining a fourth feature vector corresponding to an effect material in an effect material library according to an effect name and an effect preview image of the effect material;

in response to the similarity between the third feature vector and the fourth feature vector meeting a preset similarity condition, updating the subtitle style prediction result based on the effect material corresponding to the fourth feature vector to obtain an updated subtitle style prediction result; and

determining the candidate subtitle template according to the updated subtitle style prediction result.

Optionally, updating the subtitle style prediction result based on the effect material corresponding to the fourth feature vector includes:

replacing the effect material corresponding to the third feature vector in the subtitle style prediction result with the effect material corresponding to the fourth feature vector.

Optionally, the determining a target subtitle template from the at least one candidate subtitle template, and generating a target video according to the at least one effect material in the target subtitle template and the video in response to a trigger operation for the at least one candidate subtitle template includes:

in response to the trigger operation for the at least one candidate subtitle template, determining a candidate subtitle template associated with the updated subtitle style prediction result as the target subtitle template;

determining at least one effect material corresponding to the subtitle text according to the updated subtitle style prediction result; and

adding the at least one effect material corresponding to the subtitle text to the video to obtain the target video.

Optionally, the displaying a video and a first control in a first interface includes:

displaying the first control, the video, and a subtitle of the video in the first interface, where the subtitle of the video is associated with the subtitle text.

Optionally, the displaying the first control, the video, and the subtitle of the video in the first interface includes:

displaying the video and a second control in a second interface, where the second control is configured to trigger an event of adding a subtitle to the video;

in response to a trigger operation for the second control, determining the subtitle text according to an audio feature of the video, and annotating the subtitle text to obtain the annotation information; and

displaying the first interface, and displaying the first control, the video, and the subtitle of the video in the first interface.

Optionally, the first interface includes a preview interface or an editing interface.

Optionally, the displaying the target video in the first interface includes:

displaying the target video in the preview interface; and

in response to an edit operation for the effect material in the target video, performing edit processing for the effect material, where the edit operation includes at least one of a shifting operation, a deleting operation, or a flipping operation.

Optionally, the method further includes:

displaying a third control in the preview interface, where the third control is configured to trigger an edit event for the target video;

in response to a trigger operation for the third control, displaying the editing interface and an editing track in the editing interface, where the editing track includes a text track and/or a sticker track; and

in response to an edit operation for the text track and/or the sticker track, performing edit processing for the subtitle text in the text track, and/or performing edit processing for the sticker effect in the sticker track.

Optionally, the displaying the target video in the first interface includes:

displaying the target video and an editing track in the editing interface, where the editing track includes an effect track, the effect track includes a text track and/or a sticker track, the text track includes the subtitle text, and the sticker track includes a sticker effect.

The video processing apparatus provided in the embodiments of the present disclosure may perform the video processing method provided in any embodiment of the present disclosure, and has corresponding functional modules and beneficial effects for performing the method.

It is worth noting that the units and modules included in the preceding apparatus are only divided according to functional logic, but are not limited to the preceding division, as long as the corresponding functions may be implemented. In addition, the specific names of the functional units are only for the convenience of distinguishing from each other, and are not used to limit the protection scope of the embodiments of the present disclosure.

FIG. 11 is a schematic diagram of a structure of an electronic device according to an embodiment of the present disclosure. Reference is made to FIG. 11 below, which illustrates a schematic diagram of a structure of an electronic device (such as a terminal device or a server in FIG. 11) 1100 suitable for implementing the embodiments of the present disclosure. The terminal device in the embodiments of the present disclosure may include, but is not limited to, a mobile terminal such as a mobile phone, a notebook computer, a digital broadcast receiver, a personal digital assistant (PDA), a tablet computer (PAD), a portable multimedia player (PMP), or a vehicle-mounted terminal (such as a vehicle-mounted navigation terminal), and a fixed terminal such as a digital TV or a desktop computer. The electronic device shown in FIG. 11 is only an example, and should not impose any limitation on the functions and scope of use of the embodiments of the present disclosure.

As shown in FIG. 11, the electronic device 1100 may include a processing apparatus 1101 (such as a central processing unit or a graphics processing unit). The processing apparatus 1101 may perform various appropriate actions and processing according to a program stored in a read-only memory (ROM) 1102 or a program loaded from a storage apparatus 1108 into a random access memory (RAM) 1103. The RAM 1103 further stores various programs and data required for operations of the electronic device 1100. The processing apparatus 1101, the ROM 1102, and the RAM 1103 are connected to each other through a bus 1104. An editing/output (I/O) interface 1105 is also connected to the bus 1104.

Usually, the following apparatuses may be connected to the I/O interface 1105: an input apparatus 1106 including, for example, a touch screen, a touchpad, a keyboard, a mouse, a camera, a microphone, an accelerometer, or a gyroscope; an output apparatus 1107 including, for example, a liquid crystal display (LCD), a speaker, or a vibrator; a storage apparatus 1108 including, for example, a magnetic tape or a hard disk; and a communication apparatus 1109. The communication apparatus 1109 may allow the electronic device 1100 to perform wireless or wired communication with other devices to exchange data. Although FIG. 11 shows the electronic device 1100 having various apparatuses, it should be understood that it is not required to implement or provide all the apparatuses shown. Alternatively, more or fewer apparatuses may be implemented or provided.

In particular, according to the embodiments of the present disclosure, the process described above with reference to the flowchart may be implemented as a computer software program. For example, the embodiments of the present disclosure include a computer program product, which includes a computer program carried by a non-transitory computer-readable medium, where the computer program includes program code for performing the method shown in the flowchart. In such an embodiment, the computer program may be downloaded and installed from a network through the communication apparatus 1109, or installed from the storage apparatus 1108, or installed from the ROM 1102. When the computer program is executed by the processing apparatus 1101, the preceding functions defined in the method of the embodiments of the present disclosure are executed.

The names of messages or information exchanged between a plurality of apparatuses in the implementations of the present disclosure are only for illustrative purposes, and are not intended to limit the scope of these messages or information.

The electronic device provided in the embodiments of the present disclosure belongs to the same inventive concept as the video processing method provided in the preceding embodiments. For the technical details not described in detail in this embodiment, reference may be made to the preceding embodiments, and this embodiment has the same beneficial effects as the preceding embodiments.

An embodiment of the present disclosure provides a computer storage medium having a computer program stored thereon, where when the program is executed by a processor, the video processing method provided in the preceding embodiments is implemented.

It should be noted that the computer-readable medium in the present disclosure may be a computer-readable signal medium, a computer-readable storage medium, or any combination thereof. The computer-readable storage medium may be, for example, but not limited to, an electronic, magnetic, optical, electromagnetic, infrared, or semiconductor system, apparatus, or device, or any combination thereof. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that contains or stores a program, which may be used by or in combination with an instruction execution system, apparatus, or device. In the present disclosure, a computer-readable signal medium may include a data signal propagated on a baseband or as a part of a carrier, and computer-readable program code is carried in the data signal. The data signal propagated in this manner may be in multiple forms, and includes, but is not limited to, an electromagnetic signal, an optical signal, or any suitable combination thereof. The computer-readable signal medium may also be any computer-readable medium other than the computer-readable storage medium, and the computer-readable signal medium may send, propagate, or transmit a program used by or in combination with an instruction execution system, apparatus, or device. The program code contained on the computer-readable medium may be transmitted in any suitable medium, including but not limited to: a wire, an optical cable, a radio frequency (RF), or any suitable combination thereof.

In some implementations, a client and a server may communicate using any currently known or future developed network protocol, such as the HyperText Transfer Protocol (HTTP), and may be interconnected with any form or medium of digital data communication (for example, a communication network). Examples of the communication network include a local area network (“LAN”), a wide area network (“WAN”), an internet (for example, the Internet), a peer-to-peer network (for example, an Ad-Hoc network), and any network currently known or to be developed in the future.

The computer-readable medium may be contained in the electronic device, or may exist alone without being assembled into the electronic device.

The computer-readable medium carries one or more programs, and the one or more programs, when executed by the electronic device, cause the electronic device to:

display a video and a first control in a first interface;

determine, in response to a trigger operation for the first control, at least one candidate subtitle template according to a subtitle text of the video and annotation information of the subtitle text, and display a subtitle style interface in which the at least one candidate subtitle template is displayed, where the candidate subtitle template includes at least one effect material;

determine, in response to a trigger operation for the at least one candidate subtitle template, a target subtitle template from the at least one candidate subtitle template, and generate a target video according to the at least one effect material in the target subtitle template and the video, and display the target video in the first interface.

The computer program code for performing the operations of the present disclosure may be written in one or more programming languages or a combination thereof, where the preceding one or more programming languages include, but are not limited to, object-oriented programming languages such as Java, Smalltalk, and C++, and include conventional procedural programming languages such as “C” language or similar programming languages. The program code may be executed entirely on a computer of a user, executed partly on a computer of a user, executed as an independent software package, executed partly on a computer of a user and partly on a remote computer, or executed entirely on a remote computer or server. In the case involving the remote computer, the remote computer may be connected to the computer of the user through any kind of network, including a local area network (LAN) or a wide area network (WAN), or may be connected to an external computer (for example, connected through the internet using an internet service provider).

The flowcharts and block diagrams in the drawings illustrate the possibly implemented architectures, functions, and operations of the system, the method, and the computer program product according to the various embodiments of the present disclosure. In this regard, each block in the flowchart or block diagram may represent a module, program segment, or part of code, which includes one or more executable instructions for implementing the specified logical function(s). It should also be noted that, in some alternative implementations, the functions marked in the blocks may also occur in an order different from that marked in the drawings. For example, two blocks shown in succession may actually be performed substantially in parallel, or they may sometimes be performed in the reverse order, depending upon the functionality involved. It should also be noted that each block of the block diagrams and/or flowcharts, and a combination of the blocks in the block diagrams and/or flowcharts may be implemented in a special purpose hardware-based system that perform the specified functions or operations, or may be implemented in a combination of special purpose hardware and computer instructions.

The involved units described in the embodiments of the present disclosure may be implemented in a software manner or a hardware manner. The name of a unit does not constitute a limitation on the unit itself under certain circumstances.

The functions described above herein may be performed at least partially by one or more hardware logic components. For example, without limitation, exemplary types of the hardware logic components that may be used include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may contain or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium would include an electrical connection based on one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

The preceding description only illustrates preferred embodiments of the present disclosure and applied technical principles. Those skilled in the art should understand that the scope of disclosure involved in the present disclosure is not limited to the technical solutions formed by the specific combination of the preceding technical features, and should also cover other technical solutions formed by any combination of the preceding technical features or their equivalent features without departing from the preceding concept of disclosure. For example, a technical solution formed by a replacement of the preceding features with technical features with similar functions disclosed in the present disclosure (but not limited thereto) also falls within the scope of the present disclosure.

In addition, although the operations are depicted in a particular order, this should not be understood as requiring that such operations are performed in the particular order shown or in a sequential order. Under certain circumstances, multitasking and parallel processing may be advantageous. Similarly, although several specific implementation details are included in the preceding discussion, these should not be construed as limiting the scope of the present disclosure. Certain features described in the context of separate embodiments may also be implemented in a single embodiment in combination. On the other hand, various features described in the context of a single embodiment may also be implemented in a plurality of embodiments individually or in any suitable sub-combination.

Although the subject matter has been described in terms specific to the structural features and/or logical actions of the method, it should be understood that the subject matter defined in the appended claims is not necessarily limited to the specific features or actions described above. On the contrary, the specific features and actions described above are only exemplary forms of implementing the claims.

I/We claim:

1. A video processing method, comprising:
displaying, in a first interface, a video and a first control;
determining, in response to a trigger operation for the first control, at least one candidate subtitle template according to a subtitle text of the video and annotation information of the subtitle text, and displaying a subtitle style interface in which the at least one candidate subtitle template is displayed, wherein the candidate subtitle template comprises at least one effect material; and
determining, in response to a trigger operation for the at least one candidate subtitle template, a target subtitle template from the at least one candidate subtitle template, and generating a target video according to the at least one effect material in the target subtitle template and the video, and displaying the target video in the first interface.

2. The method of claim 1, wherein determining the at least one candidate subtitle template according to the subtitle text of the video and the annotation information of the subtitle text comprises:
determining target subtitle content in the subtitle text according to the annotation information of the subtitle text, and determining a target effect material of a preset style according to a similarity between the target subtitle content and an effect material of the preset style in an effect material library; and
determining the at least one candidate subtitle template according to the target effect material of the preset style.

3. The method of claim 2, wherein determining the target effect material of the preset style according to the similarity between the target subtitle content and the effect material of the preset style in the effect material library comprises:
determining a first feature vector according to the target subtitle content;
determining a second feature vector according to an effect name and an effect preview image of the effect material of the preset style; and
determining the target effect material according to a similarity between the first feature vector and the second feature vector.

4. The method of claim 3, wherein determining, in response to the trigger operation for the at least one candidate subtitle template, the target subtitle template from the at least one candidate subtitle template, and generating the target video according to the at least one effect material in the target subtitle template and the video comprises:
determining the target subtitle template of the preset style in response to the trigger operation for the at least one candidate subtitle template;
determining at least one target effect material corresponding to the subtitle text according to a similarity between the first feature vector corresponding to the subtitle text and the second feature vector corresponding to the target subtitle template; and
obtaining the target video by adding the at least one target effect material corresponding to the subtitle text to the video.

5. The method of claim 1, wherein determining the at least one candidate subtitle template according to the subtitle text of the video and the annotation information of the subtitle text comprises:
determining a subtitle style prediction result according to the video, the subtitle text, and the annotation information, wherein the subtitle style prediction result comprises the subtitle text and a recommended effect material, and the recommended effect material comprises a recommended effect name and a recommended effect preview image;
determining a third feature vector corresponding to the recommended effect material according to the recommended effect name and the recommended effect preview image;
determining a fourth feature vector corresponding to an effect material in an effect material library according to an effect name and an effect preview image of the effect material;
updating, in response to a similarity between the third feature vector and the fourth feature vector meeting a preset similarity condition, the subtitle style prediction result based on the effect material corresponding to the fourth feature vector to obtain an updated subtitle style prediction result; and
determining the candidate subtitle template according to the updated subtitle style prediction result.

6. The method of claim 5, wherein updating the subtitle style prediction result based on the effect material corresponding to the fourth feature vector comprises:
replacing an effect material corresponding to the third feature vector in the subtitle style prediction result with the effect material corresponding to the fourth feature vector.

7. The method of claim 5, wherein determining, in response to the trigger operation for the at least one candidate subtitle template, the target subtitle template from the at least one candidate subtitle template, and generating a target video according to the at least one effect material in the target subtitle template and the video comprises:
determining, in response to the trigger operation for the at least one candidate subtitle template, a candidate subtitle template associated with the updated subtitle style prediction result as the target subtitle template;
determining at least one effect material corresponding to the subtitle text according to the updated subtitle style prediction result; and
obtaining the target video by adding the at least one effect material corresponding to the subtitle text to the video.

8. The method of claim 1, wherein displaying the video and the first control in a first interface comprises:
displaying the first control, the video, and a subtitle of the video in the first interface, wherein the subtitle of the video is associated with the subtitle text.

9. The method of claim 8, wherein displaying the first control, the video, and the subtitle of the video in the first interface comprises:
displaying the video and a second control in a second interface, wherein the second control is configured to trigger an event of adding a subtitle to the video;
determining, in response to a trigger operation for the second control, the subtitle text according to an audio feature of the video, and obtaining the annotation information by annotating the subtitle text; and
displaying the first interface, and displaying the first control, the video, and the subtitle of the video in the first interface.

10. The method of claim 1, wherein the first interface comprises a preview interface or an editing interface.

11. The method of claim 10, wherein displaying the target video in the first interface comprises:
displaying the target video in the preview interface; and
editing, in response to an edit operation for the effect material in the target video, the effect material, wherein the edit operation comprises at least one of a shifting operation, a deleting operation, or a flipping operation.

12. The method of claim 10, further comprising:
displaying a third control in the preview interface, wherein the third control is configured to trigger an edit event for the target video;
displaying, in response to a trigger operation for the third control, the editing interface and an editing track in the editing interface, wherein the editing track comprises a text track and/or a sticker track; and
editing, in response to an edit operation for the text track and/or the sticker track, the subtitle text in the text track, and/or a sticker effect in the sticker track.

13. The method of claim 10, wherein displaying the target video in the first interface comprises:
displaying the target video and an editing track in the editing interface, wherein the editing track comprises an effect track, the effect track comprises a text track and/or a sticker track, the text track comprises the subtitle text, and the sticker track comprises a sticker effect.

14. An electronic device, wherein the electronic device comprises:
one or more processors,
a storage, configured to store one or more programs,
wherein the one or more programs, when executed by the one or more processors, cause the one or more processors to:
display, in a first interface, a video and a first control;
determine, in response to a trigger operation for the first control, at least one candidate subtitle template according to a subtitle text of the video and annotation information of the subtitle text, and display a subtitle style interface in which the at least one candidate subtitle template is displayed, wherein the candidate subtitle template comprises at least one effect material; and
determine, in response to a trigger operation for the at least one candidate subtitle template, a target subtitle template from the at least one candidate subtitle template, and generate a target video according to the at least one effect material in the target subtitle template and the video, and display the target video in the first interface.

15. The electronic device of claim 14, wherein the one or more programs causing the one or more processors to determine the at least one candidate subtitle template according to the subtitle text of the video and the annotation information of the subtitle text comprise instructions to:
determine target subtitle content in the subtitle text according to the annotation information of the subtitle text, and determine a target effect material of a preset style according to a similarity between the target subtitle content and an effect material of the preset style in an effect material library; and
determine the at least one candidate subtitle template according to the target effect material of the preset style.

16. The electronic device of claim 15, wherein the one or more programs causing the one or more processors to determine the target effect material of the preset style according to the similarity between the target subtitle content and the effect material of the preset style in the effect material library comprise instructions to:
determine a first feature vector according to the target subtitle content;
determine a second feature vector according to an effect name and an effect preview image of the effect material of the preset style; and
determine the target effect material according to a similarity between the first feature vector and the second feature vector.

17. The electronic device of claim 16, wherein the one or more programs causing the one or more processors to determine, in response to the trigger operation for the at least one candidate subtitle template, the target subtitle template from the at least one candidate subtitle template, and generate the target video according to the at least one effect material in the target subtitle template and the video comprise instructions to:
determine the target subtitle template of the preset style in response to the trigger operation for the at least one candidate subtitle template;
determine at least one target effect material corresponding to the subtitle text according to a similarity between the first feature vector corresponding to the subtitle text and the second feature vector corresponding to the target subtitle template; and
obtain the target video by adding the at least one target effect material corresponding to the subtitle text to the video.

18. The electronic device of claim 14, wherein the one or more programs causing the one or more processors to determine the at least one candidate subtitle template according to the subtitle text of the video and the annotation information of the subtitle text comprise instructions to:
determine a subtitle style prediction result according to the video, the subtitle text, and the annotation information, wherein the subtitle style prediction result comprises the subtitle text and a recommended effect material, and the recommended effect material comprises a recommended effect name and a recommended effect preview image;
determine a third feature vector corresponding to the recommended effect material according to the recommended effect name and the recommended effect preview image;
determine a fourth feature vector corresponding to an effect material in an effect material library according to an effect name and an effect preview image of the effect material;
update, in response to a similarity between the third feature vector and the fourth feature vector meeting a preset similarity condition, the subtitle style prediction result based on the effect material corresponding to the fourth feature vector to obtain an updated subtitle style prediction result; and
determine the candidate subtitle template according to the updated subtitle style prediction result.

19. The electronic device of claim 18, wherein the one or more programs causing the one or more processors to update the subtitle style prediction result based on the effect material corresponding to the fourth feature vector comprise instructions to:
replace an effect material corresponding to the third feature vector in the subtitle style prediction result with the effect material corresponding to the fourth feature vector.

20. A non-transitory storage medium comprising computer-executable instructions, wherein the computer-executable instructions, when executed by a computer processor, cause the computer processor to:
display, in a first interface, a video and a first control;
determine, in response to a trigger operation for the first control, at least one candidate subtitle template according to a subtitle text of the video and annotation information of the subtitle text, and display a subtitle style interface in which the at least one candidate subtitle template is displayed, wherein the candidate subtitle template comprises at least one effect material; and
determine, in response to a trigger operation for the at least one candidate subtitle template, a target subtitle template from the at least one candidate subtitle template, and generate a target video according to the at least one effect material in the target subtitle template and the video, and display the target video in the first interface.
